(19) United States
(12) Patent Application Publication
(10) Pub. No.: US 2008/0003055 A1
(43) Pub. Date: Jan. 3, 2008

(54) Disk Carrier Comprising a Snap Ring

(75) Inventor: Gert Bauknecht, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSCHAFEN AG, Friedrichshafen (DE)

(21) Appl. No.: 10/593,603

(22) PCT Filed: Mar. 22, 2005
(86) PCT No.: PCT/EP05/02998

§ 371 Date: Oct. 26, 2006

(30) Foreign Application Priority Data
Mar. 23, 2004 (DE) 10 2004 014 112.6

(51) Int. Cl. F16B 21/18

(52) U.S. Cl. 403/375

(57) ABSTRACT

A disk carrier which has a locking profile for receiving a disk assembly that can be axially fixed by a snap ring inserted in a groove. The locking profile and the groove are produced by non-cutting shaping. The groove has a groove base and two groove flanks and the snap ring has two faces. The groove flank supporting the snap ring is provided with an undercut having an angle of inclination α. Both groove flanks are arranged in parallel relative each other. The groove is produced by punching using a punch knife which is radially guided in a slanted plane that is tilted by the angle of inclination a relative to a radial plane. The faces of the snap ring are conical and have an angle of inclination β, whereby β≧α and the maximum diameter of the snap ring is located in the area of the groove base.

This application is a national stage completion of PCT/EP2005/002998 filed Mar. 22, 2005 which claims priority from German Application Serial No. 10 2004 014 112.6 filed Mar. 23, 2004.

### FIELD OF THE INVENTION

The invention concerns a disk carrier.

### BACKGROUND OF THE INVENTION

Snap rings, i.e., safety rings, are already known as standard construction components. These rings serve for the axial positioning of two parts, wherein the ring itself is held in a circumferential groove and is subjected to spring loading, whereby it abuts against that component which is to be positioned. In a case of extreme operational demands, namely, for example a very high speed of rotation, spring tension can no longer compensate for the so generated severe pressure forces and vibrations. The result of such excessive loadings, is that the snap ring develops a tendency to migrate out of its position as determined by the circumferential groove. On this account, various proposals have been presented to prevent such a displacement of a snap ring from its prescribed groove.

DE-A 25 08 677, of the applicant, proposes the provision of a second snap ring, which is to be placed outside of the first ring for the securement thereof. This calls for additional, radial construction space which is not always available, especially in the case of compactly constructed transmissions.

In an older patent application of the Applicant, designated as DE-103 02 075.6, a snap ring security measure for disk carriers in a transmission is taught, wherein the ejection of a snap ring outward or inward from its proper position is prevented by the presence of inclined inserts, or ramps. A movement of the snap ring in a circumferential direction is blocked by a lug which obstructs such rotary impulses. This securement requires a careful manipulation of the snap ring during the mounting thereof, which extended mounting requires additional installation time.

Thus it is the purpose of the invention to improve a disk carrier of the type described in the introductory passages. In other words, the purpose is to improve a system of a snap ring in a circumferential groove in such a manner, that the positional security of the snap ring is simplified, the manufacture of the snap ring and its components is improved and a greater ease of assembly is achieved.

### SUMMARY OF THE INVENTION

In accordance with the invention, the circumferential groove is undercut to present an inclined surface. The sides of the groove, however, remain parallel to one another, whereby the side of the groove which abuts the snap ring is given an undercut with an angle of inclination designated as α. The snap ring itself is conically shaped, thereby exhibiting an inclination angle of β, wherein β≧α. In a case of axial loading of the snap ring in the direction of undercut groove side, because of shape-alteration, the snap ring is hindered in an attempt to escape its circumferential groove and, on this account, may be considered secured in it position. In this way, the advantage of a simple securement for the snap ring is gained without additionally added parts and without additional effort in the mounting thereof. Thereby, in that the inclination angle β of the snap ring could well be greater than the angle of inclination, namely α, of the groove side, the advantage is achieved, in that the resultant line of force F is in the direction of the inside circumference of the groove, that is to say, toward the maximum width of the aforesaid conical snap ring, whereby bending tensions of the carrier are reduced, especially in the outer area which is remote from the disk packet. In this way, it is possible that this portion of the snap ring, that is, the circumferentially, outer standing part of the ring, otherwise known as the “crown area”, can be designed to be somewhat shorter than normal. This is a distinct advantage in the case of compactly assembled automatic transmissions for motor vehicles. The invented manufacture of the circumferential groove, following the profile of the disk carrier in metal construction, can be carried out by stamping operations. The die equipment of the stamping machine, which carries out the metal formation, is itself of slanted positioning, wherein the angle of inclination represents, again, the angle α, on which account, the parallel-running stamping edges, namely the groove sides arise. The so invented undercut, angled circumferential groove is thus made without machining, which simplifies the manufacture and reduces the cost thereof.

The invented undercut groove sides, in connection with conical snap ring can be installed as an outer disk carrier with an inner profile as well as being installed as an inner disk carrier with an outer profile. In such arrangements, in any case, different conical snap rings can be acquired. In the case of inner profiling, the snap ring tapers itself from the outer to the inner circumferences.

In another advantageous embodiment of the invention, the angle of inclination a is advantageously set at 2°, a value at which a satisfactory shape-fit, i.e., a securing effect can be achieved.

### BRIEF DESCRIPTION OF THE DRAWING

The invention will now be described, by way of example, with reference to the accompanying drawing in which:

FIG. 1 is an enlarged section of an outside disk holder of a shifting element in an automatic transmission for motor vehicles.

### DETAILED DESCRIPTION OF THE INVENTION

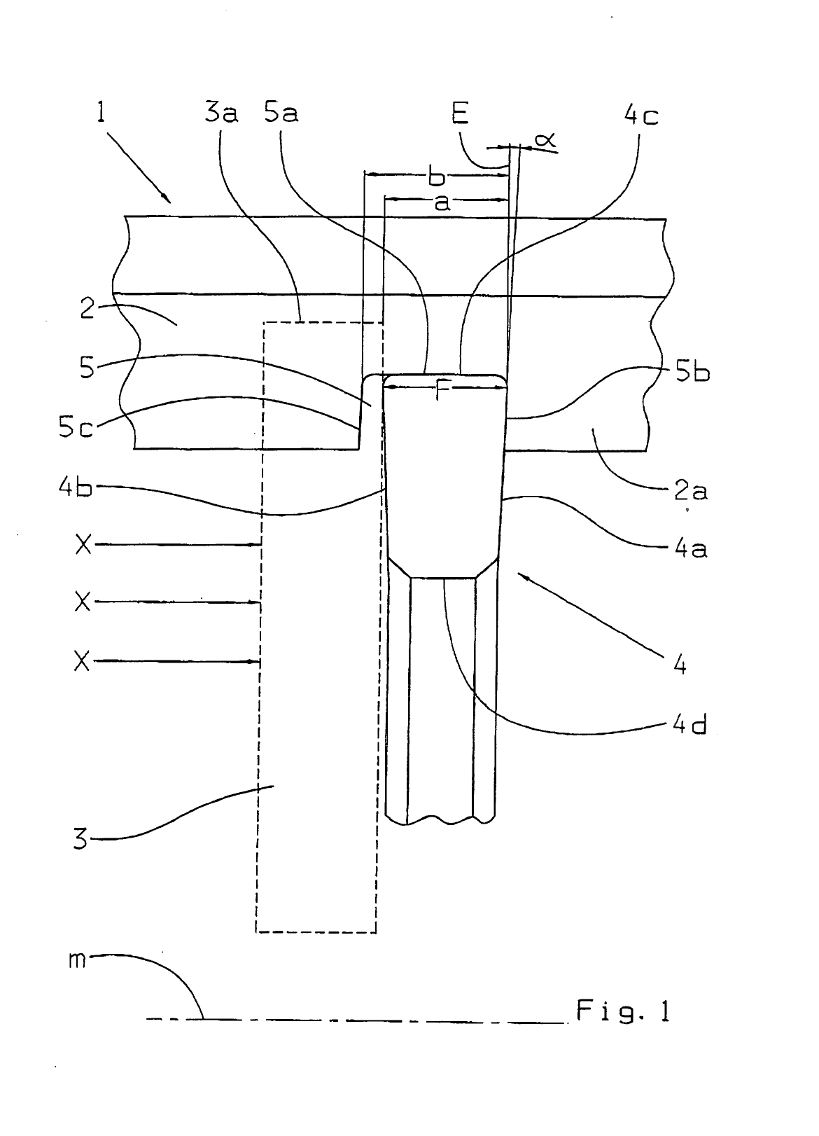

The FIG. 1 shows an enlarged section of an outside disk holder 1 of a (not shown) shifting element in an automatic transmission for motor vehicles. Disk holders of this type are known, for example, by the above mentioned patent application of the applicator with the official serial No. 103 02 075.6. A shifting element incorporates, as a rule, outer disk carriers, which have an inner profile for the acceptance of an outer profile of outer disks and inner disk carriers having an outer profile for the acceptance of an inner profile of inner disks. The disk carriers are somewhat pot-shaped. That is to say, they are cylindrically designed and made of sheet steel, whereby the profile can be stamped or rolled out. To this extent, the disk carrier is made by metal-formation and does not require machining. The partially presented disk carrier is an outer disk carrier with a central axis, here shown in a displaced position and has an inner profile 2, which has designed teeth, somewhat trapezoidal in cross-section with spacing between them. Into this, profile 2 engages an outside toothing of a disk packet, which shows only the most external disks 3 in dotted outline. This can also be shown as a pressure disk. The disks, or alternately, the pressure disk 3 possess an external toothing 3a, which meshes with the acceptance profile toothing 2. The outside disks or the pressure disk 3 is directed in accordance with the arrows X by pressure from the prestressed disk packet (not shown) and abuts itself against a snap ring 4, which is secured in a circumferential, complementary groove 5. The groove of the snap ring 5 possesses two inner sides, namely 5a, 5b and also a circumferential surface 5c, the width of which runs parallel to the central axis of the snap ring. The inner groove surface is slanted, and possesses an angle of inclination designated as α, which measures, for example, 2°, that is to say, the groove side 5b is undercut. The angle of inclination α is relative to radial plane E, which serves as a reference plane. In the same Figure, to the left, side 5c runs parallel to right side 5b, however, is not undercut. The groove 5 is made by a stamping machine (not shown) executing a radially movement toward the outside, following a plane slated at the angle of inclination α. On this account, the two groove sides run, corresponding to the movement direction of the stamping machine, parallel to one another. The making of the groove 5 is thus done without machining, since the material of the disk holder 1 is sheared and—without material loss—pressed to the outside. The snap ring 4 possesses two flat surfaces 4a, 4b, which are in a conical relationship to one another. That is to say, they taper from their outside diameter 4c in the direction of their inner diameter. These flat surfaces 4a, 4b, i.e., end faces, possess an angle of inclination β which is equal to, or greater than the angle of inclination α of the groove side 5b. Also, again, the angle of inclination β is relative to the radial plane E. In this way, the side surface 4a is either parallel to or at an acute angle to the groove side 5b may be seen by the dotted line 4a′ and the angle β′ which is greater than α. The abutment force of the outside disk, i.e., the pressure disk 3, which force is directed into the disk carrier 1, or more exactly said, effectively brought into the accepting profile 2, is designated in FIG. 1 by two arrows F. Because of the side to side agreement of the angles α and β the resultant force F, which is in the neighborhood of the inner circumference of the groove 5a, migrates. That is to say, the supporting force F, practically without cause from a bending moment, is introduced into the outer area 2a of the inner profile 2. This is especially and assured action, if the angle β is larger than the angle of inclination α. That portion of the disk carrier 1 which lies outside of the disk packet and the snap ring is designated as the crown area and is thus loaded only by tensile forces, which results in a considerably more favorable disposition of force. The crown area 2a, on this account, can be smaller and thus become even more space saving than otherwise.

The action for securement of the invented snap ring 4 is achieved in combination with the undercut groove side 5b which, in combination with the directed pressure by the outside disks 3, forms a shape-fit arrangement, which has a radial inward movement of the snap ring 4. In other words, a release of the snap ring 4 from inside the groove 5 to the outside is prevented. FIG. 1 shows—as has been mentioned—an outside disc carrier with an inner profile and a snap ring, the cross-section of which tapers down in the direction from its outer diameter to its inner diameter. The invention, however, can be put to effective use with the same action and the same advantages that an inner disk carrier would possess, if the latter had an outer profile available, whereby the groove had the same geometry in its outer profile as is the case with the already described profile. The snap ring, in any case, which is to be inserted into the groove, must exhibit a counter conicity. That is to say, it must exhibit in its cross-section a growth from its outside diameter to its inside diameter, where the inner diameter lies in coincidence with the base of the groove, namely 5a. One can easily place this in an imaginary realm, if one inverts FIG. 1, i.e., turns it 180°, whereby essentially the circumferential surface of the snap ring is to be ignored.

The invention, where the disk carrier is concerned, has been described as a somewhat potshaped, steel sheet metal, profiled, component made without machining. Accordingly, the snap ring can also be made without machining. That is to say, it can be made by stamping in a vertical direction, which direction is not in a vertical configuration with the axis of rotation. It is within the framework of the invention, to employ the invented combination of a conical snap ring and undercut groove sides even for other profiled, sheet steel pot-shaped objects.

Reference Numerals

1 disk carrier
2 profile for engagement
2a crown area
3 outside disks
3a outside profiling
4 snap ring
4a face of side (of snap ring), conically disposed
4a′ face of side (of snap ring), conically disposed
4b face of side (of snap ring), conically disposed
4c outside diameter (contiguous to 5a)
4d inside diameter (of snap ring)
5 circumferential groove to hold snap ring
5a surface of diameter of groove
5b inner side of groove (as observing FIG. 1, on right side)
5c inner side of groove (as observing FIG. 1, on left side)
a width at outside diameter of snap ring
b width of groove 5
m axis of rotation
E radial plane, reference plane for angles
α angle of inclination, side of groove
β angle of inclination, one face of snap ring
β′ angle of inclination, other face of snap ring.

1-4. (canceled)

5. A disk carrier (1) with a complementary profile (2) for acceptance of a disk packet (3), which is axially affixed by a snap ring (4) inserted in a groove (5), the groove (5) having an internal circumferential surface (5a) and two groove sides (5b, 5c), the snap ring (4) having two flat faces (4a, 4b), a first groove side (5b) which abuts against the snap ring (4) having an undercut with a first angle of inclination (α), the first groove side (5b) being parallel to a second groove side (5c), the groove (5) being made by stamping to provide a slanted surface at the first angle of inclination (α) with reference to a radial plane (E), the two flat surfaces (4a, 4b) of the snap ring being conically inclined with respect to one another at a second angle of inclination (β), the second angle of inclination (β) being greater than the first angle of inclination (α) and a maximum width (a) of the snap ring (4) is placed adjacent the internal circumferential surface (5a) of the groove (5).

6. The disk carrier according to claim 5, wherein the disk carrier is an outside disk carrier (1) and the complementary profile is an inner profile (2).

7. The disk carrier according to claim 5, wherein the disk carrier is an inside disk carrier and the complementary profile is an outside profile (2).

8. The disk carrier according to claim 5, wherein the first and the second angles of inclination (α, β) are respectively related to the reference plane (E), which is a radially positioned plane, and the first angle of inclination (α) is about 2°.
